(19) United States
(12) Patent Application Publication
(10) Pub. No.: US 2016/0228917 A1
(43) Pub. Date: Aug. 11, 2016

(54) SCREEN PANEL LOCKING SYSTEM

(71) Applicant: Lettela Pty Limited, Airport West (AU)

(72) Inventors: RAYMOND MAXWELL WOODGATE, Bacchus Marsh (AU); Marc Raymond Woodgate, Bacchus Marsh (AU)

(21) Appl. No.: 15/040,067

(22) Filed: Feb. 10, 2016

(30) Foreign Application Priority Data
Feb. 10, 2015 (AU) 2015900407

(51) Int. Cl. B07B 1/46

(52) U.S. Cl. CPC B07B 1/4645; B07B 1/469

(57) ABSTRACT

A screening apparatus includes a plurality of spaced apart, substantially parallel beams and a plurality of screen panels mounted to the beams to form a planar screening surface. Elongate side walls are provided on opposite sides of the screening apparatus and side edges of edge panels extend in close facing relationship to the side walls. Elongate side clamps are mounted to the side walls and have a bottom edge for bearing against an upper surface of the side edge of the edge panels. The side edges of the edge panels include locating gaps and the side clamps include projections, whereby the projections are received within the locating gaps to locate the edge panels relative to the side clamps against movement of the edge panels lengthwise of the side clamps.

### CROSS REFERENCE TO RELATED APPLICATIONS

This application claims priority to Australian Patent Application No. 2015900407 filed on Feb. 10, 2015, which is hereby incorporated by reference in its entirety.

### TECHNICAL FIELD

The present invention relates generally to apparatus for screening, separating or grading materials, and is principally for use in the mining industry. The present invention is particularly directed to arrangements for fixing screen panels to the support frame of a vibratory screening machine and to the screen panels themselves. The system and panels are applicable for screening, separating and grading ores and other materials, and it will be convenient to hereinafter describe the invention in relation to that use. It is to be appreciated, however, that the invention is not limited to such apparatus and use.

### BACKGROUND OF INVENTION

A reference herein to prior art is not to be taken as an admission that the prior art was known or that it was part of the common general knowledge as at the priority date of any of the claims.

Screening apparatus of the type with which the invention is concerned is generally used for screening, grading, or separating materials such as ores and comprises an array of screen panels which are removably fixed to a frame to provide a continuous screen deck. The material to be screened is fed onto the deck at one end and the apparatus is vibrated so that the material moves over and through its screening surface. The vibration forces are significant.

The screen panels in a screen deck are usually subject to wear, due to the abrasiveness of the mining materials typically being screened, and thus the screens require periodical replacement. This presents a difficulty with the attachment of the panels to the deck frame, as the attachment must be secure and robust and easily made, but it should also be releasable in a manner that is quick and easy. Applicant has developed several different forms of screen panel attachments, examples of which can be found in Australian patent no. 2012201297 and Australian patent no. 2012208984.

In addition to the need for screen panels to be easily attachable and releasable to and from a screen deck frame, screen panels should also be firmly secured in place on the deck and the screen array should not present gaps for passage of screening product or media other than through the openings formed in the screens themselves. If gaps do exist, then incorrect grade screening product can pass through the deck, or the screening product can become embedded between components of the screening deck and can cause wear to the screen panels or the screen deck frame. This can result in the need to clean parts of the vibratory machine or replace parts, either of which results in downtime of the vibratory machine.

Screen decks are therefore formed with either the side edges of adjacent screen panels abutting, or with cover strips employed between adjacent screen panels to overlie any gaps between the adjacent side edges. A screen deck can thus usually be formed without any gaps being present. However, if there is any movement of the screen panels during operation of the vibratory machine, then gaps can result. One form of movement that can create gaps is movement of screen panels in the direction of travel of the screening product over the screening deck. This type of movement is more likely to occur in so-called multi-slope or “banana” screening decks, in which the lead or initial section of deck is inclined or curved to increase the speed of the screening product across the initial section of the screening deck. Such screening decks can also provide other benefits or effects such as to promote water shedding from the screening product. For at least these reasons, the use of multi-slope screening decks is preferred in many installations. However, in the inclined or curved section of the screening deck, the screening product moves at high speed and the forces associated with that movement tends to push the screen panels over which the screening product travels. If the screen panels move under that load, gaps between panels can arise.

The present invention seeks to provide an arrangement in which the screen panels at the edge of the screen deck are located or secured in position against movement of the kind described above. The present invention does not concern itself with movement of screen panels that are inboard of the edge of the screen deck although it will be appreciated that the elimination of movement of screen panels at the edge of the screen deck will assist to prevent movement of the screen panels inboard of the edge, because there will be no forces from the edge panels acting on the inboard panels tending to cause them to move. The elimination of movement is intended once the screen panels at the edge of the screen deck have been finally positioned or installed, such that in some forms of the invention, movement of the screen panels at the edge is allowed for installation purposes, but movement is prevented once the panels have been fully installed ready for operation of the vibratory machine.

### SUMMARY OF INVENTION

According to the present invention there is provided a screening apparatus, including:
a plurality of spaced apart, substantially parallel elongate beams,
a plurality of screen panels mounted to the beams to form a broad, generally planar screening surface,
a pair of elongate side walls on opposite sides of the screening apparatus, side edges of screen panels that form an edge of the screening surface (hereinafter “edge panels”) extending in close facing relationship to the side walls,
elongate side clamps mounted to the side walls and having a bottom edge for bearing against an upper surface of the side edges of the edge panels of the screening surface,
the side edges of the edge panels including locating gaps and the side clamps including projections, whereby the projections are received within the locating gaps to locate the edge panels relative to the side clamps against movement of the edge panels lengthwise of the side clamps.

A screening apparatus as above described advantageously prevents lifting movement of the side edges of the edge panels by the bearing engagement of the side clamp on the side edges, while the screening apparatus also secures the side edges of the edge panels against movement lengthwise of the side clamps by the engagement of the projections of the side clamps within the locating gaps of the edge panels. Thus the side edges of the edge panels are secured against movement that could otherwise result in the formation of gaps between adjacent screen panels.

A screening apparatus as above described can be employed with any suitable screening apparatus in which side edge location of the edge panels is required. One particular form of screening apparatus to which the present invention is applicable has been developed by the applicant and includes a plurality of spaced apart, substantially parallel elongate beams and a plurality of screen panels mounted to the beams to form a broad screening surface. Each of the panels has a generally square or rectangular shape defining a first pair of substantially parallel edges and a second pair of substantially parallel edges. The panels are mounted adjacent to each other so that facing side edges of adjacent panels are in close facing relationship, while each panel is mounted to a pair of beams to bridge between two adjacent beams.

The panels are mounted to the beams by elongate fixing members that extend in the longitudinal direction of the beams and that engage the first pair of side edges of the panels. The fixing members have a pair of upstanding, generally longitudinal rails that are generally parallel and that are spaced apart to define a longitudinal gap between them. The panels are mounted to the beams by cooperation between the first pair of side edges of each panel with a rail of a fixing member. The first pair of side edges of each panel includes a longitudinal overhang that overlies an upper end of a rail and the overhang enters the gap between the rails. Each of the rails of each fixing member and the overhang of each panel are interrupted to form gaps that are aligned and within which a locking member is disposed to locate the panel relative to the fixing rail against movement of the panel along the fixing rail.

In the above form of screening apparatus, the edges of adjacent panels that are spaced from or remote from the side walls of the screening apparatus are secured against movement by the use of the locking members. However, the edge panels adjacent the side walls of the screening apparatus are not connected to fixing rails and therefore, the use of locking members at those edges is not available. Thus, the present invention can be used to secure the side edges of the edge panels and with those side edges secured according to the invention, all of the screen panels of the screening apparatus can be fully secured against movement. This is highly advantageous.

A further advantage of the present invention is that the edge panels are not secured in place until the projections enter the locating gaps and the side clamp is also secured in place. In this respect, the side clamps can be left loose during the assembly of the screen panels to the screening apparatus until the screen panels have all been located, such as by the locking members of the screening apparatus discussed above. The side clamps can then be positioned for receipt of the projections within the locating gaps and once received, the side clamps can be clamped in place. This means that the edge panels can be shifted as required prior to securing them in place so that the edge panels can be properly positioned in the screening apparatus to eliminate gaps in the screen deck. This shifting movement is usually quite small.

Still further, removal of an edge panel is not obstructed by the receipt of the projections within the locating gaps, because once the other edges of the edge panels are freed from any locating devices, the edge panels can simply be pulled out from underneath the side clamps, releasing the projections from the locating gaps. This means that the edge panels are very easy to remove for replacement.

Screen panels for use in a screening apparatus according to the invention can have an identical shape. This has advantages in production and storage of panels (reducing the number of different panels needing to be stored), while installation is facilitated given that the single form of panel can be used across a complete screening deck. Where a screening apparatus employs locking members as discussed above, the gaps provided in the edges of the screen panels for receipt of the locking members can also form the locating gaps for receipt of the projections of the side clamps. The projections need simply to be positioned appropriately for alignment with the gaps and sized for receipt within the gaps.

The side clamp of a screening apparatus according to the present invention will extend longitudinally of the screening apparatus for substantially the extent or length of the screen panels and the side clamp will cooperate with a clamping arrangement which can for example engage an upper edge of the side clamp to push or press the side clamp downwards.

The projections preferably have a width between opposite side surfaces measured lengthwise of the side clamps that is substantially equal to the spacing between facing side surfaces of the locating gaps, so that the side surfaces of the projections engage the side surfaces of the locating gaps. In this way, engagement between the opposite side surfaces of the projections and the facing side surfaces of the locating gaps prevents relative movement between the side edges of the edge panels and the side clamps.

Also, the projections preferably have a depth or length laterally to the lengthwise direction of the side clamps that the projections extend into contact with the inboard end of the locating gaps. In this way, lateral movement of the edge panels toward the side clamps is restrained. Thus, the edge panels are restrained at their side edges against movement lengthwise of the side clamps as well as laterally to the side clamps.

In preferred forms of the invention, the projections do not extend into engagement with the inboard end of the locating gaps, but rather, extend toward the inboard end but terminate prior to engaging the inboard end. In these forms of the invention, the projections can include plugs to bridge between the projections and the inboard end, so that the ends of the plugs extend into contact or engagement with the inboard end of the locating gaps. This form of the invention is advantageous, in that the length of the plug can be selected on the basis of the gap to be filled between the projection and the inboard end of the locating gaps. Where that gap varies, the form and size of the projection can also vary. This means that the size of the projections does not need to be varied and thus a single form of side clamp with one size of projection can be employed in different forms and sizes of screening apparatus, rather than forming a variety of different side clamps with projections of different depth or length.

The use of plugs attached to projections is also advantageous to deal with inaccuracy in screening apparatus. For example, the side walls of the screening apparatus might not be completely straight from one end of the apparatus to the other, so that where a projection might engage the inboard end of a locating gap at one point of the screen deck, at a different point, the projection might be slightly spaced from the inboard end. In that case, movement of an edge panel might not be sufficiently restrained laterally to the lengthwise dimension of the side clamps, so that gaps between adjacent panels could arise. Accordingly, by the use of plugs, which can be varied in length or depth, variations in the distance or space between a projection and the inboard end of a locating gap can be accommodated by selecting different sized plugs. This means that in a screening deck according to the invention, different sized plugs can be employed along the length of the side walls.

The plugs are preferably releasably connectable to the projections, so that in the event that an inappropriately sized plug is initially connected to a projection, the plug can be removed and replaced with a plug of correct length or depth. The alternative is for the plugs to be permanently connected to the projections after the initial connection is made.

The plugs can be connected to the projections in any suitable manner, such as by a threaded connection, a bayonet connection, or a snap-fit connection. However, in one form of the invention developed by the applicant, each projection includes an opening and each plug includes a head, a neck and a base, wherein the neck is of a smaller diameter than both the head and the base. In this arrangement, the plugs are connected to the projections by the plug extending through the opening in the projections so that the head is positioned between the projection and the inboard end of the locating gap, the neck is positioned within the opening of the projection, and the base is positioned on the opposite side of the projection to the head. The head and the base can be arranged to be in engagement with opposite sides of the projection to firmly secure the plug to the projection. The neck can be a loose fit within the opening or a close fit, such as a friction fit.

In the above arrangement, the base of the plugs could be removed, so that the plugs can consist of a head and neck only and in this arrangement, the neck can be a friction fit within the opening of the projection to secure the plug to the projection. The neck alternatively could be a loose fit and the plug could be retained connected to the projection by connection or engagement of the head of the plug with the inboard end of the locating gap.

In the above arrangements incorporating a head, a neck and a base, the base must be able to be pushed through the opening of the projection and to expand on the opposite side of the projection once it is through the opening. Accordingly, at least the base, but preferably the entire plug, must be formed from a flexible, or resilient or distortable material so that the base can be collapsed and recover once it is through the opening. In some forms of the invention, the plugs are formed from polyurethane, although other materials could be employed.

Where plugs are employed, the plugs include a portion that bridges between the projection and the inboard end of the locating gaps to engage the inboard end. That bridging portion can also have a width between opposite side surfaces, measured lengthwise of the side clamps, that is substantially equal to the spacing between facing side surfaces of the locating gaps, so that like the projections, side surfaces of the plugs engage the side surfaces of the locating gaps. This is considered to potentially assist location of the side edges of the edge panels against movement lengthwise of the side clamps, particularly where the projections do not have a depth which is sufficient to enter a substantial portion of the locating gaps.

The bridging portion of the plugs can be generally square or rectangular, or alternatively, it can be generally circular. The portion can, of course, be any suitable shape, but the above identified forms are preferred.

The projections can extend from any appropriate part of the side clamps, but preferably they extend from the bottom edge of the side clamps. The side clamps can also have a rear surface in facing engagement with the side walls of the screening apparatus and an opposite, front surface. The bottom edge of the side clamps can extend between the front and rear surfaces and the projections that extend from the bottom edge can extend inboard of the rear surface so that where the plugs include a base, the base can be positioned between the rear side of the projections and the rear surface of the side clamps, so that the base of the plugs is in engagement with the side wall. That engagement between the base and the side wall supports the plug and thus the projection so that a pushing or bearing load imposed by the edge panels on the plugs is resisted by engagement between the base of the plugs and the side walls.

The edge panels, like the panels inboard of the edge panels, have a height between the upper surface of the side edges and the opposite lower surface. In the present invention, the projections, and if provided, the plugs, can have a height that is equal to the height between the upper and lower surfaces, or the height can be less than that height. In arrangements considered by the applicant to date, the projections and plugs can be less than half the height of the side edges, and for example can be approximately one third or one quarter of that height. In some arrangements according to the invention, the plugs extend from proximate the upper surface of the side edges of the edge panels and terminate prior to the opposite lower surface. In arrangements in which the projections extend from the bottom edge of the side clamps, the projections will extend from proximate the upper surface of the side edges of the edge panels and depending on the height of the projections, can extend to the opposite lower surface or to a position prior to that surface as described above.

Where the projections extend from the bottom edge of the side clamp, it is not necessary that the projections extend for the full thickness of the side clamps between the front and rear surfaces. In some forms of the invention, the projection is positioned inboard of the rear surface of the side clamp (as discussed above) as well as being inboard of the front surface. In this arrangement, the surface of the bottom edge that is forward of the projections (in the direction of the screen panels) can bear against the upper surface of the side edges of the edge panels when the side clamp is clamped into position. This means that despite the provision of the projections extending from the bottom edge of the side clamp, the side clamp can nevertheless continuously clamp against the upper surface of the side edges of the edge panels for the full length of the side clamp.

The width of the projections relative to the width of the side clamp between front and rear surfaces can be any suitable ratio, and is dependent on the dimensions of the locating gaps provided in the side edges of the edge panels. What is required is that the projections are positioned and dimensioned sufficient to extend into the locating gaps to provide the longitudinal location required. As indicated above, the connection of plugs to the projections can extend the width or depth of the projections, for greater penetration into the locating gaps, but the preference is that the projections always extend into the locating gaps to at least some extent.

While any number of locating gaps can be provided on the side edges of the edge panels, two locating gaps appear to be appropriate, and the preference is that these are spaced apart towards opposite sides of the edge panels.

### BRIEF DESCRIPTION OF DRAWINGS

In order that the invention may be more fully understood, some embodiments will now be described with reference to the figures in which:

FIG. 1 is an isometric view of a portion of a screening deck according to one embodiment of the invention.

FIG. 2 is a cross sectional view through II-II of FIG. 1 showing the connection between adjacent screening panels in the deck illustrated in FIG. 1.

FIG. 3 is an exploded view of a single screening panel and its connection to the deck of FIG. 1.

FIG. 4 is an assembled view of the arrangement of FIG. 3.

FIG. 5 is an exploded view of a single screening panel and its connection to the deck of FIG. 1 but showing an elongate fixing member.

FIG. 6 is an isometric view of a locking member for use in a screening apparatus.

FIG. 7 is a cross sectional view through VII-VII of FIG. 1 showing the locking member of FIG. 6 in place.

FIGS. 8 and 9 show alternative forms of locking members.

FIG. 10 is an isometric view of a side clamp according to one embodiment of the invention.

FIG. 11 is an end view taken in the direction A of FIG. 1.

FIG. 12 is a cross sectional view through XII-XII of FIG. 1.

FIG. 13 is a cross sectional view of a plug according to an embodiment of the invention.

FIG. 14 is an isometric view of a side clamp according to one embodiment of the invention.

FIG. 15 is a cross sectional view of a plug according to a further embodiment of the invention.

### DETAILED DESCRIPTION

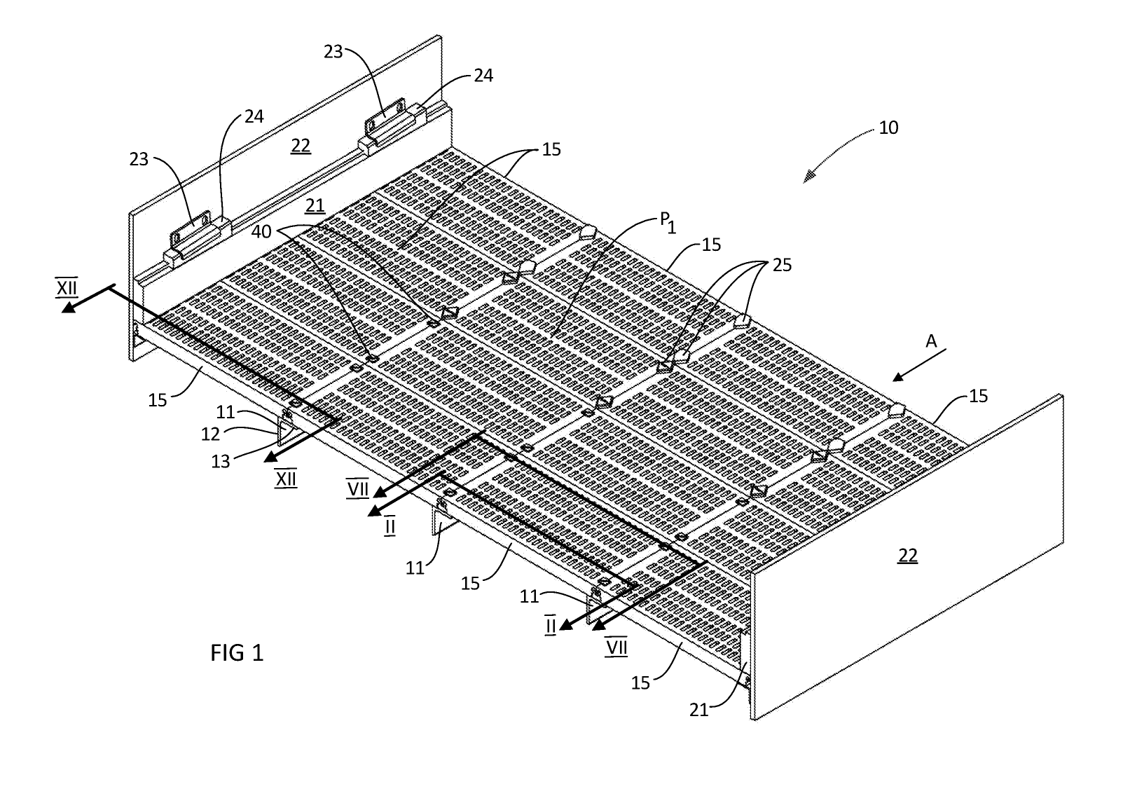

With reference to FIG. 1, a portion of a screening deck 10 is illustrated, comprising a plurality of elongate, longitudinal beams 11 each of which is formed from an angle of steel having a long portion 12 and short portion 13. The portions 12 and 13 are set at right angles to each other. While the beams 11 extend in the longitudinal direction of the screening deck 10, the beams 11 can equally extend perpendicular to the direction shown.

The deck 10 illustrated in FIG. 1 is a portion of a deck only and illustrates a depth across the deck 10 of four screening panels 15. The longitudinal length of the deck 10, in the direction of the beams 11 can be much greater.

The beams 11 extend parallel to one another and support the panels 15 on the upper face of the short portion 13 of each beam 11. The panels 15 illustrated in FIG. 1 can be of any suitable size, but a common size is 305 mm by 610 mm. The screening deck 10 is one part of an overall screening apparatus. The screen deck 10 is supported on a sub frame which includes the beams 11 and which is part of a vibratory screen machine. The vibration that is generated is significant and requires the panels 15 to be securely fixed to the beams 11. The panels 15 are also subject to wear over time and even though the fixing of the panels 15 to the beam 11 are required to be secured, the preference is that the panels are also easily releasable to facilitate replacement.

The panels 15 include a plurality of openings through the top surface thereof for screening product such as mining ore. The openings in the panel can vary from large to very small depending on the screened media required from the screening process.

Typically, ore is fed onto one end of the deck 10 and the deck is vibrated so that the ore tends to shift from one end to the other with some of the ore passing through the openings of the panels 15 as it travels over the deck. Depending on the operation, the valuable ore could be the ore which passes through the openings, or the ore which remains on the deck. The panels 15 are attached to the screen deck 10 via elongate fixing members 20 which are mostly obscured in FIG. 1, but which are shown in other figures. The fixing members 20 are fixed to the upper surface of the short portion 13 of the beams 11 by any suitable arrangement, such as bolts. The fixing members can extend for a single length of a single panel 15, or, more preferably, for a greater number of panels, such as five panels.

Most of the panels 15 will be in face to face engagement along side edges of each panel. For example, the panel marked P₁ is engaged with facing edges of other panels 15 on all four edges. It is preferred that the panels have this face to face engagement, in order to prevent or minimise screening product from entering into the junction between adjacent panels 15 and through that junction to the beams 11 below or into the screened product that is collected below the screen deck. Any entry of such screening product between adjacent panels 15 can cause wear to the fixing members 20, or to the beams 11, thus compromising operation of the screening deck 10. With sufficient wear, worn components must be replaced and that results in down time of the screening apparatus. Wear of certain components, such as the beams 11, can require significant down time in order to replace the components. It is therefore important that the panels 15 be fixed to the deck 10 securely and with firm side edge engagement between adjacent panels.

It is to be noted that the deck 10 includes side clamps 21 at each side of the deck 10, and in facing engagement with side walls 22. Side clamps 21 clamp via a bracket 23 and wedge 24 onto the upper edge surface of the panels 15 for the purpose of preventing lifting of the facing edge of the panels 15, preventing ingress of screening product between the side edges of the panels 15 and the walls 22, and also to protect the walls 22 (which are usually steel walls), from the impact of screening product which traverses the screen deck 10. The side clamps 21, like the panels 15, are usually made from a polyurethane material. The side clamps 21 can be used with a screening apparatus of the invention or with prior art screening apparatus.

The manner in which the screen panels 15 interact with the fixing members 20 will be described hereinafter. For that discussion, it is important to note from FIG. 1, the existence of locking members 25 that assist to locate the panels 15 relative to the fixing rails 20 against movement of the panels 15 along the fixing rails. In this respect, while the deck 10 is shown as a flat, screening decks generally operate on an incline to promote travel of ore from one end of the deck (the feed end) to the other (the discharge end), and some decks incorporate inclined sections (these can be referred to as “multi-slope decks”), in order to increase the speed of ore from the feed end to the discharge end. The inclined sections can have a greater inclination at the start of the deck and reduce towards only a slight inclination so that screening product decelerates from a high speed at the entry or initial section of the screening deck, to a lower speed when the screening deck flattens out to a slight incline. These types of decks process the screening product more quickly than decks that have only a slight and constant incline over the length of the deck because the screening product travels over the deck more quickly due to the more greatly inclined sections.

Particularly in the multi-slope types of decks, there is tendency for the screening panels to shift in the direction of screening product movement due to the loads placed on the panels by the moving screening product and that shift can cause gaps to open between adjacent panels and for screening product to fall through those gaps causing the problems mentioned above in relation to wear of deck components or contamination of screened product. For this reason, the screening apparatus disclosed herein is intended to lock the panels 15 firmly in position on the fixing members 20 in order to prevent such panel shifting movement. That locking however is intended to be selective in that the screening apparatus can allow movement of the panels 15 relative to the fixing members 20 to allow proper and accurate location of the panels 15 on the fixing members 20, but once the panels 15 are correctly located, the panels can be locked against further movement relative to the fixing members 20. This differs from some prior art arrangements where the screening panels are locked as soon as they are fixed to the fixing members, so that initial pre-fixing movement along or relative to the fixing members is not provided or allowed.

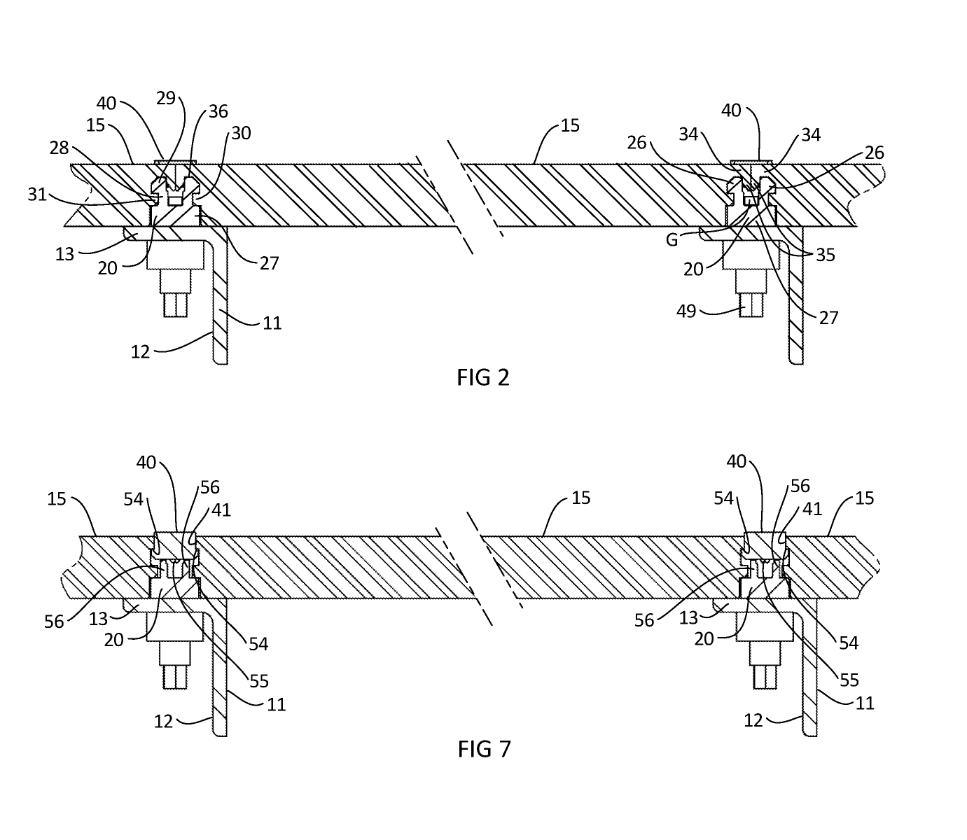

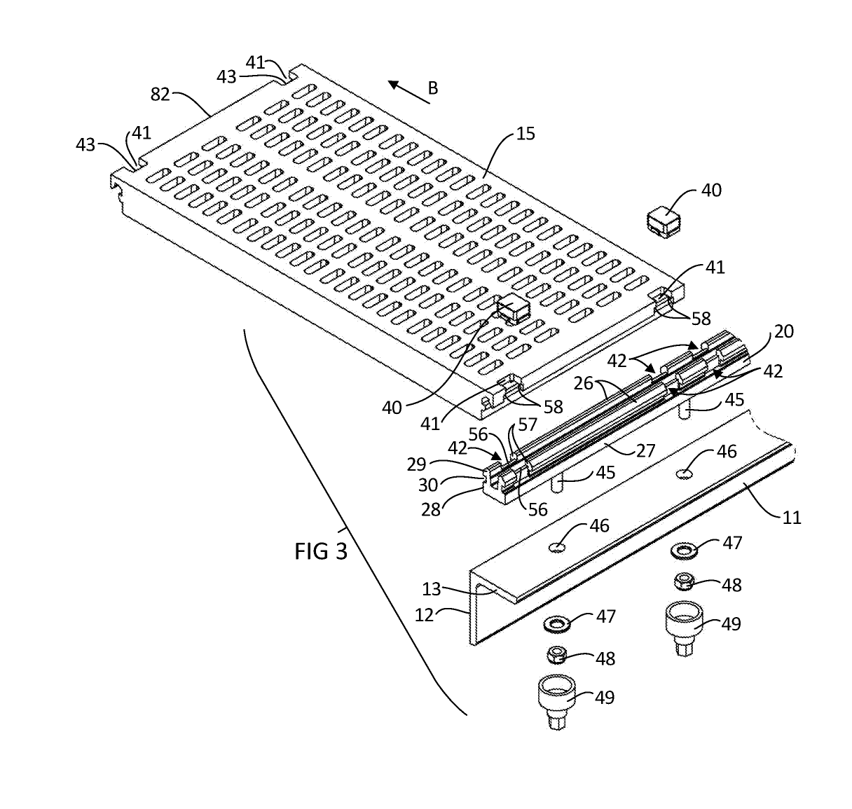

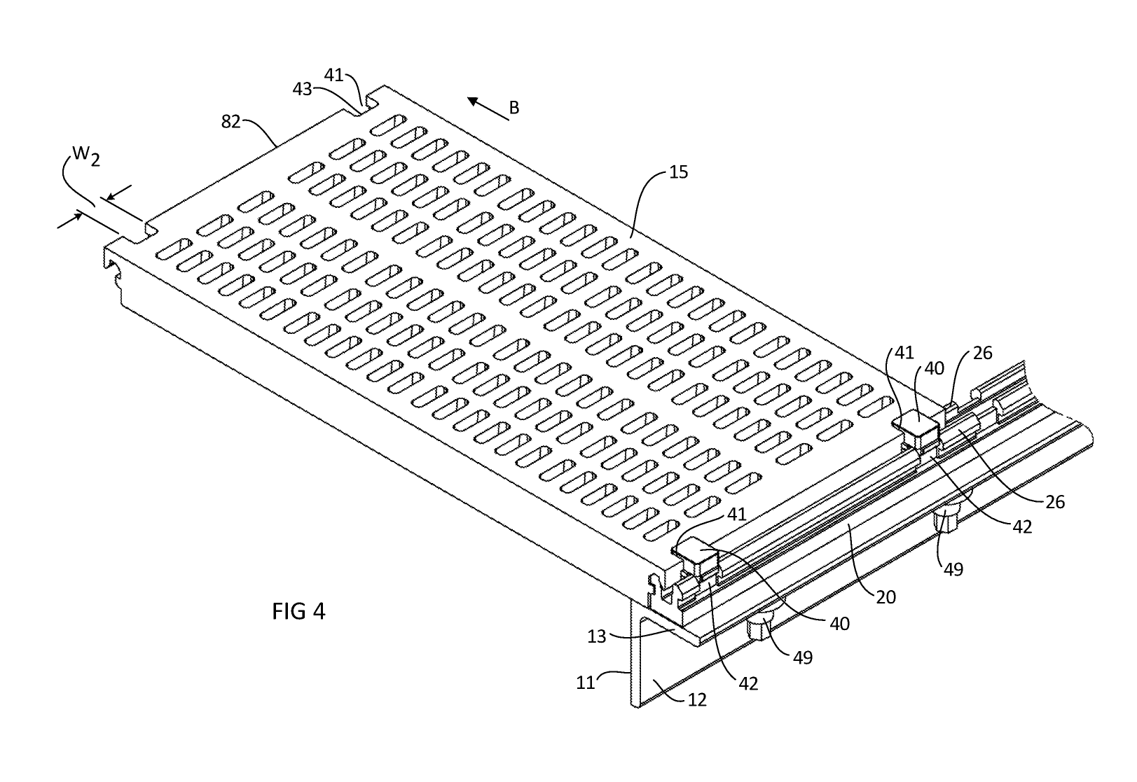

With reference to FIG. 2, a cross-sectional view of one full panel 15 (the central panel), and side edges of two adjacent panels 15 (to the left and right of the central panel) is illustrated. FIGS. 3 and 4 are exploded and assembled views of a single panel 15 relative to a single fixing member 20. FIGS. 2 to 4 show the configuration of the fixing members 20 and show that the fixing members 20 include a pair of rails 26 which extend from a base 27 and which are formed by webs 28 and heads 29. Recesses 30 are defined between the base 27 and the heads 29 and it can be seen that the side edges of the panels 15 each include a projection 31 that extends into the recesses 30 in order for the side edges of the panels 15 to cooperate with the rails 26 of the fixing members 20 to fix the panels 15 to the fixing members 20 and thus to the beams 11.

The side edges of the panels 15 also include a longitudinal overhang 34 (FIG. 2) that overlies the upper end of the rails 26, or in other words overlies the heads 29 and includes a downwardly extending portion 35 that extends into the gap G (FIG. 2) between adjacent rails 26. It is intended that facing surfaces of facing portions 35 engage tightly to prevent ingress of screening product between the portions 35 and into the fixing members 20.

The panels 15 are securely located on the beams 11 by cooperation between the projection 31 of the side edges of the panels 15 within the recess 30 of the fixing members 20. The panels 15 can be connected to the fixing members 20 by the projections 31 riding down the inclined surface 36 of the heads 29 and by the rails 26 bending inwardly towards each other as the projection 31 moves over the inclined surface 36 for insertion into the recess 30. With the projection 31 seated within the recess 30, the portion 35 is positioned within the gap G, and when a pair of panels have been assembled to the fixing member 20 as shown in FIG. 2, the respective portions 35 engage and prevent inward flexing or tipping of the rails 26 towards each other. By this arrangement, side edges of the panels 15 are securely held in place on the fixing members 20 by the secure engagement of the projections 31 within the recesses 30.

However, as indicated above, it is a feature of the screening apparatus that the panels 15 are not only secured in the array formation shown in FIG. 1, but also against movement along the fixing members 20. In the illustrated form of the screening apparatus, prevention of that latter form of movement is by the use of locking members 40 that fit into locating gaps which are formed in the overhang 34 and in the rails 26. With reference to FIG. 3, gaps 41 are formed in the overhang 34, while gaps 42 are formed in the rails 26 of the fixing member 20. The gaps 41 and 42 form a locating gap into which the locking member can be inserted.

With reference to FIG. 4, with the gaps 41 and 42 aligned or overlaid, the locking members 40 can be inserted and it will be appreciated that once inserted, the locking members 40 lock the position of the panel 15 on the fixing member 20 through engagement with the edges of the gaps 41 and 42. While the locking members 40 remain in place, movement lengthwise of the panel 15 along the fixing member 20 is not possible.

The figures mentioned above also show the manner by which the fixing members are fixed to the beam 11 and while this is a relatively standard arrangement, it will be briefly described as follows.

Extending from the base 27 of the fixing member 20 are a pair of projections 45 (FIG. 3) that extend through openings 46 in the portion 13 of the beams 11 and while the projections 45 are not shown as being threaded, they include a thread over which the washers 47 pass and on which the nuts 48 thread. The nuts 48 tighten the fixing members 20 onto the beam 11, while a urethane cap 49 is also threaded onto the end of the 45 to protect the fixing arrangement (the projections 45, washers 47 and the nuts 48) against the corrosive effect of fines (very fine screening product).

The fixing members 20 can be of any length suitable to secure one or more panels 15. FIG. 5 illustrates a fixing member 50 that is of a length suitable to fix four panels 15 thereto. It is envisaged that for commercial use, the fixing members 20 will have at least the length shown in FIG. 5 but potentially a greater length, although a smaller length is possible.

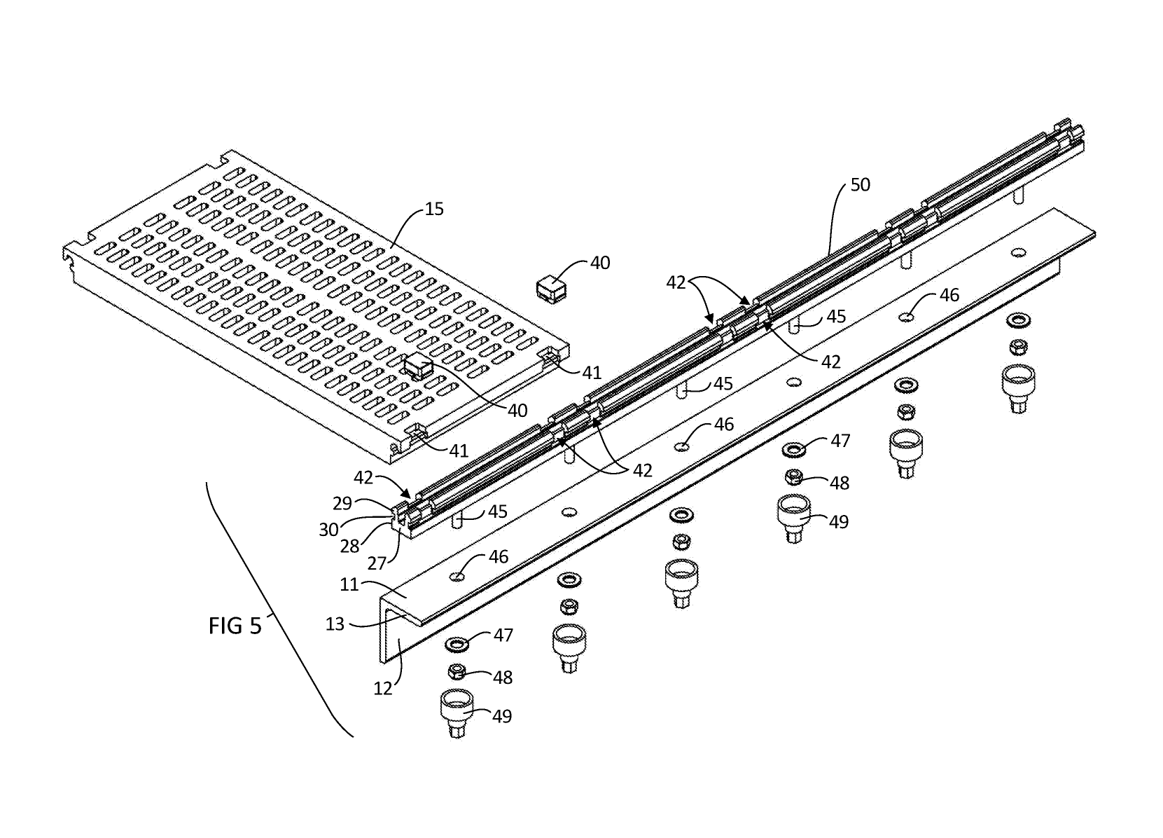

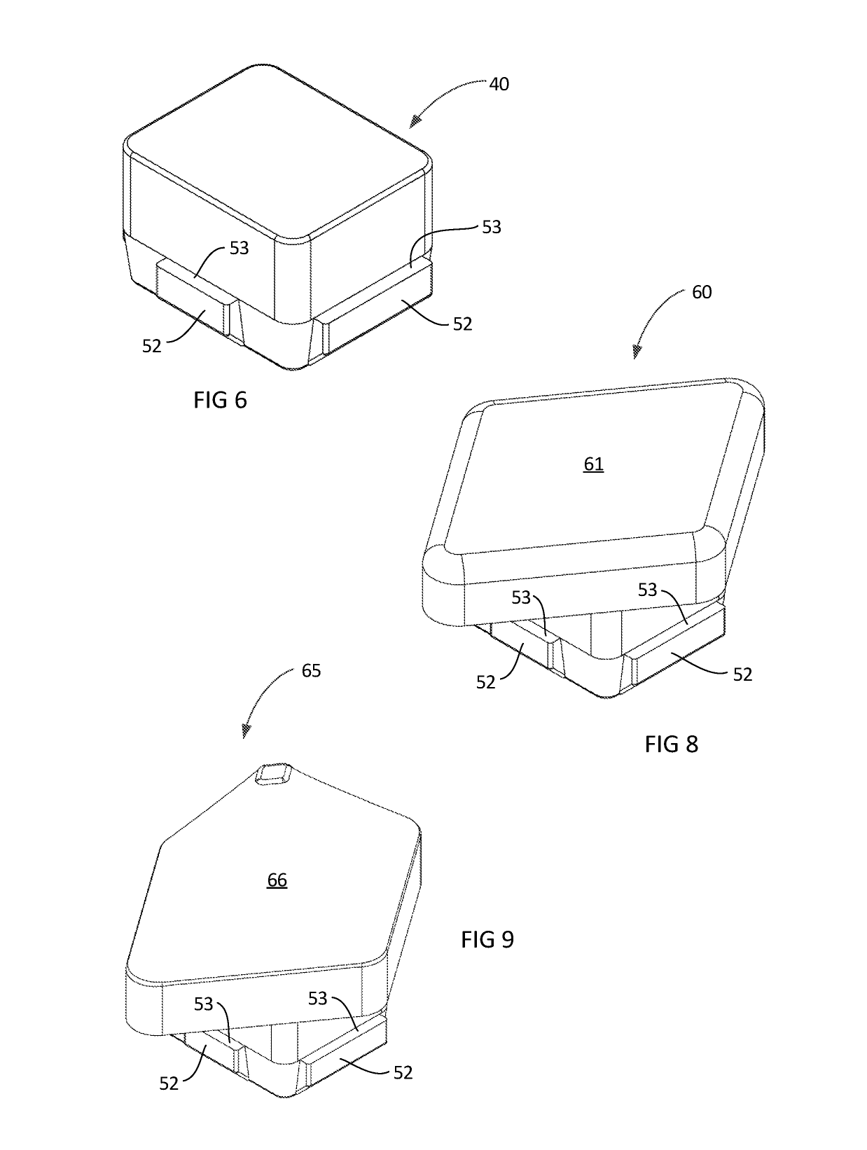

The locking members 40 must firmly lock into the gaps 41 and 42 and must be constructed to maintain that locking engagement under operation of the deck 10 during a screening operation in which the deck is vibrated. Accordingly, the locking members 40 include a construction that is illustrated in FIGS. 6 and 7 and with reference to those figures, it can be seen that the locking member 40 has a generally rectangular shape and includes four projections or undercuts 52. Each undercut 52 projects from a side wall or edge of the locking member 40 and includes an upper surface 53. As shown in FIG. 7, two of the undercuts 52 on opposite sides of the locking members 40 engage a downwardly facing surface 54 of the inner edges or walls of the gaps 41 in adjacent panels 15 in order to lock the locking members 40 in place. The other two the undercuts 52 engage a downwardly facing surface of the other walls (the side walls) of the gaps 41 as will be below. The locking members 40 are intended to be a tight fit within the locating gaps formed by the overlying gaps 41 and 42.

There is sufficient flexibility in the undercuts 52 in order to simply push the locking members 40 into the gaps 41 of an adjacent pair of panels 15 with the undercuts 52 compressing or deflecting to allow the locking members 40 to enter the gaps 41 and for the undercuts 52 to thereafter splay or flex outwardly once the upper surface 53 has penetrated to a position just below the downwardly facing surfaces 54. As shown in FIG. 7, the bottom face 55 of each locking member 40 rests on upwardly facing surfaces 56 (see FIGS. 3 and 4), of the rails 26 in the region of the gaps 42. By this arrangement, each of the panels 15 and the locking member 40 are firmly secured in place and because the locking member 40 is a tight fit within the gap 42, so that it bears against facing surfaces 57 (see FIG. 3) of the heads 29 of the rails 26, longitudinal movement of the locking members 40 is precluded and thus longitudinal movement of the panels 15 is also precluded.

While the undercuts 52 engage the surfaces 54 of the inner walls of the panels 15 as shown in FIG. 7, the undercuts 52 also engage further downwardly facing surfaces 58 of the side walls that extend from the inner walls as shown in FIG. 3, so that the locking member 40 is secured against release out of the gaps 41 and 42 on each of its four sides. This forms a highly secure fitting.

Locking members 25 and 40 are illustrated in FIG. 1, and from this, it can be seen that the locking members 25 have different shapes on the surface of the deck 10 to the locking members 40. The form of the locking members can vary and two other forms are illustrated in more detail in FIGS. 8 and 9. Each of the locking members 40, 60 and 65 have the same bottom or base end defining a rectangular shape with four undercuts 52. It is only the upper part of the locking members that differ and in FIG. 8, the locking member 60 is shown to have a diamond shaped upper end 61, while in FIG. 9, the locking member 65 has a pyramid shaped upper end 66. The upper ends 61 and 66 are shaped as deflectors, so that screening product travelling along the deck 10, that travels along the adjoining sections of adjacent panels 15 in which no screening openings exist, is deflected back onto portions of the screening panels that do have screening openings.

Returning to FIG. 1, it will be evident that the arrangement which exists between adjacent side edges of adjacent panels 15 cannot be employed along the walls 22 of the deck 10 because there is no adjacent panel for the side edge panels to engage or abut. Nevertheless, is it important to secure the panels at the edges (referred to earlier as “edge panels”) against longitudinal movement of the deck 10 at the side walls 22, so that the edge panels 15 that extend to the side walls 22 are also fully located against longitudinal movement. Also, it is important to secure the edge panels 15 against lateral movement toward and away from the side walls and against lifting movement away from the beams 11 of the screen deck.

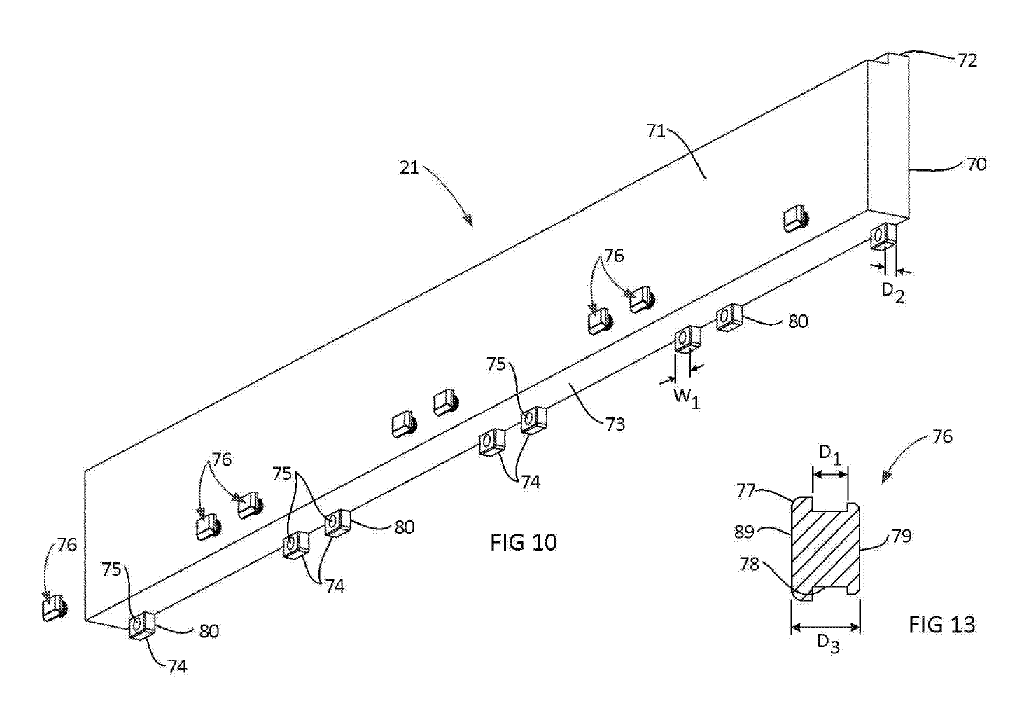

For this, the side clamps 21 have been configured so that they can support plugs or spacers (hereinafter “plugs”) for interaction with the side edges of the edge panels 15. With reference to FIGS. 10 to 13, the side clamp 21 includes a rear face 70, a front face 71, an upper stepped edge 72 which is engaged by the wedge 24 for securing the side clamp 21 in place, and a lower or bottom edge 73. Extending from the lower edge 73 are projections 74 that each include an opening 75 for receipt of a plug 76, which is shown in side cross sectional view in FIG. 13.

From FIG. 13, it can be seen that the plug 76 has a head 77, a neck 78 and a base 79. The dimensions of the openings 75 are such to snuggly or closely accept the neck 78, and the arrangement is that the base 79 is sufficiently flexible to allow it to be pushed through the smaller diameter opening 75 and to splay or recover once through the opening 75 to engage against the rear surface 80 of the projections 74, with the surface 80 being slightly inboard of the rear face 70 of the side clamp 21 so that the rear of the base 79 is coextensive with the rear face 70. This means that the base 79 will engage against the side wall 22 and be supported by the side wall 22. The distance D₁ between the bottom surface of the head 77 and the facing surface of the base 79 is also configured to be approximately the same as the distance D₂ between front and rear surfaces of the projections 74.

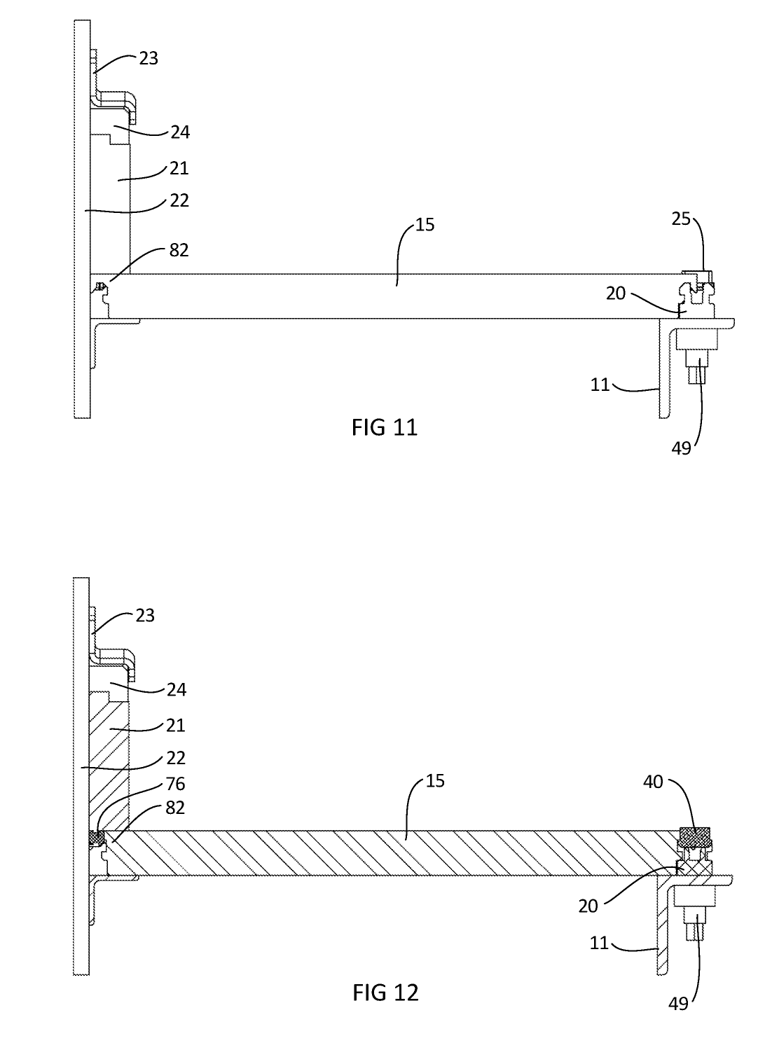

With reference to FIGS. 3 and 4, and assuming for the purposes of the description in relation to the plugs 76, that the side edge 82 of the panel 15 of FIGS. 3 and 4 is the side edge 82 shown in FIGS. 11 and 12, then it will be apparent that the side edge 82 includes openings or gaps 41 (see FIGS. 3 and 4) that are proximate the facing surface of the wall 22. The projections 74 of the side clamp 21 shown in FIG. 10 are therefore spaced apart for alignment with the gaps 41 in the side edge 82. The projections 74 of the side clamp 21 also have a width dimension W₁ (see FIG. 10) that is the same, or just slightly smaller than the width dimension W₂ of the gaps 41 (see FIG. 4). When the projections 74 are located within the gaps 41, side edges of the projections 74 bear against facing surfaces of the gaps 41 to locate the side edge 82 against longitudinal movement in the direction A (see FIG. 1) between the feed and discharge ends of the screen deck 10. By this arrangement, the side edge 82 is secured against that longitudinal movement to the same extent that that movement is secured at the opposite ends of the panels 15 by the earlier described locking members 25, 40, 60 or 65.

The engagement should be enough to prevent longitudinal movement of the panels 15 in the direction A of FIG. 1. The fit of the projections 74 preferably should therefore be an interference type fit within the gaps 41. The bearing engagement can be firm engagement and the dimensions of the projections 74 and the gaps 41 can be made so that the panels must be forced into position on the projections 74, However, such a tight engagement is not considered to be absolutely necessary, so that a friction fit could be acceptable or even a slightly loose fit.

For the panels 15 to be secured against lateral movement toward and away from the side walls 22 (movement in the direction B as shown in FIGS. 3 and 4), contact must be made with the inside, inboard or base surfaces 43 of the gaps 41, It is not intended that the projections 74 will engage the base surfaces 43, although in some arrangements this could occur, but rather, it is the intention that the plugs 76 engage the base surfaces 43, The plugs 76 can be made in different lengths or sizes as explained below, to accommodate variations in the spacing between the base surfaces 43 and the facing surface of the projections 74 of different screening decks or machines,

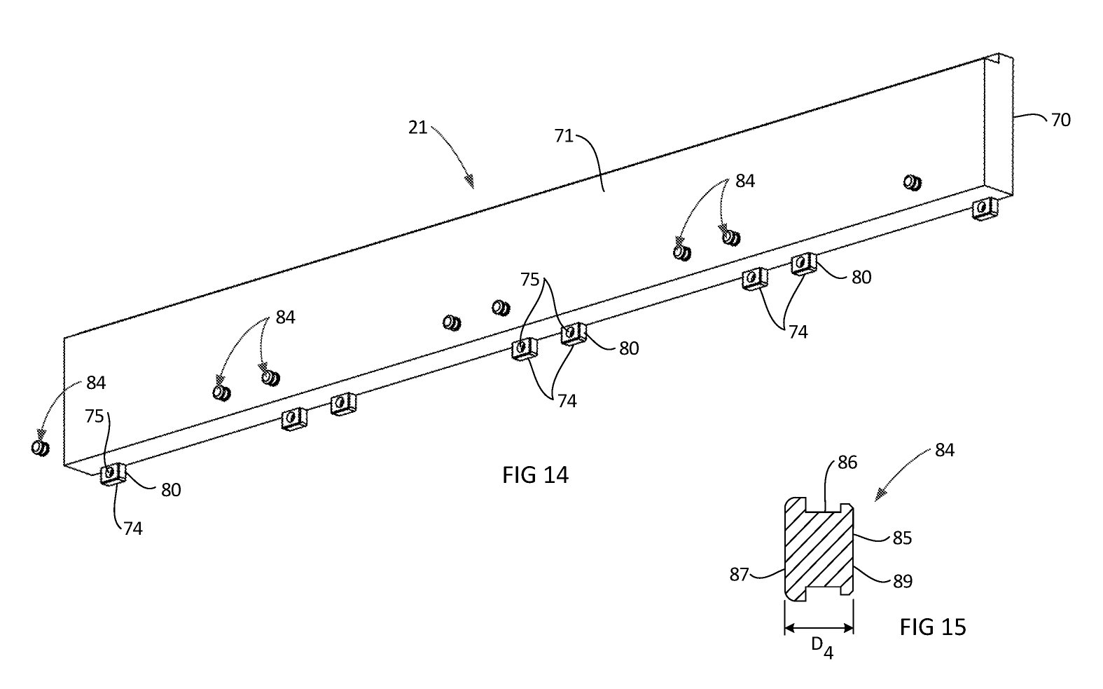

The plugs 76 are proposed to be separate from the projections 74, so that different sized plugs can be used to accommodate different spacing between the base surfaces 43 and the facing surface of the projections 74 as necessary. Thus, in relation to FIG. 14, the side clamp 21 is again shown, having the same features and thus the same reference numerals as the side clamp 21 as shown in FIG. 10. However, in FIGS. 14 and 15, plugs 84 are illustrated and those plugs have a different and reduced depth D₄ compared to the depth D₃ of the plug 76 of FIG. 13. The plug 84 has a head 85, a neck 86 and a base 87. The dimensions of both the neck 86 and the base 87 can be the same as the neck 78 and the base 79 of the plug 76. Where the dimension differs in the respective plugs 76 and 84 is in the dimension or depth of respective heads 77 and 85. As can be seen in FIGS. 13 and 15, the head 77 is of greater dimension or depth compared to the head 85.

The dimensions of the plug 84 is for snug or close receipt of the neck 86 within the openings 75, with the base 87 being sufficiently flexible to allow it to be pushed through the smaller diameter opening 75 and to splay or recover once through the opening 75 to engage against the rear surface 80 of the projections 74 in the same manner as the plugs 76 of FIGS. 10 and 13.

The different sizes or depth of the plugs 76 and 84 illustrated in FIGS. 10 and 14 allows compensation for slight variations in the total width of the screening deck 10 between the opposite side walls 22 (see FIG. 1) of different machines, or for inaccuracy of the side walls along the length of the screen deck from feed end to discharge end. This is important, because while the distance between the side walls 22 is specified for each screening deck, there can be slight variation along the length of the deck between the side walls (such as by slight bowing of the sides walls along their length), so that the size of the plug needed to engage the base surface 43 of the screen panels 15 can also vary. Moreover, different screen deck manufacturers manufacture their screen decks to different widths and where the variation between the width of the screen decks of different manufacturers varies by a few millimetres (say up to 30 mm), the same side clamp can be used for each deck with the plugs being selected based on the distance that the plugs need to bridge in order to ensure edge engagement between adjacent screen panels.

It is necessary for the plugs 76 and 84 to engage the inboard or base surface 43 of the gaps or openings 41. The engagement should be enough to prevent lateral movement of the panels 15 in the direction B of FIGS. 3 and 4. The fit of the plugs 76 and 84 should preferably be an interference type fit so that the faces 89 of the plugs 76 and 84 bear against the base surfaces 43 of the gaps 41. The bearing engagement can be firm engagement. The heads 77 and 85 can be made so that the panels must be forced into position against the plugs 76 and 84, although such a tight engagement is not considered to be absolutely necessary. What is necessary is that the heads 77 and 85 of the plugs 76 and 84 take up the gap between the projections 74 and the facing base surfaces 43 and bear against the base surfaces 43.

The plugs 76 and 84 can have the same width dimension W₁ (see FIG. 10) as the projections 74, so that the plugs 76 and 84 can also engage facing surfaces of the gaps 41 in the same way as the projections 74 engage facing surfaces of the gaps 41 to prevent longitudinal movement of the panels 15 in the direction A of FIG. 1. However, this is not a requirement. Also, where the plugs 76 and 84 have the same width dimension W₁ as the projections 74, the plugs 76 and 84 might not contribute much to the resistance of longitudinal movement of the panels 15, particularly where the dimension of the head 77 or 85 of the plugs 76 and 84 is small. Where the head dimension is larger, then the plugs 76 and 84 can contribute to the resistance of longitudinal movement.

The screen deck 10 can be assembled by first installing a full row of panels 15 at each of the feed and discharge ends of each fixing rail. These can be easily installed from above the screen deck 10 which is important for the safety of the installation personnel. The fixing members 20 can be fixed to the beams 11 loosely at first so that they can be shifted on the beams 11 to properly align the first rows of panels 15 as required. The side clamps can also be loosely fixed for later tightening.

With only the rows of panels at the feed and discharge ends of each fixing rail in place, there is space between the feed and discharge ends so that the installer has access to beneath the beams 11 to the nuts 48 to tighten the nuts and fix the fixing members 20 in place. Further rows of panels can be installed to the fixing rails between the initial rows at the feed and discharge ends and while there are still some panels absent from the deck, access to beneath the deck remains available. Thus, successive rows can be installed, all from above the deck. Prior to installing the final panels, the fixing members must be fully fixed in place while access to nuts 48 from above the screen deck remains available. This process can take place for all of the sets of fixing rails between the feed and discharge ends of the overall screen deck.

The edge panels can be slid in beneath the side clamps 21 so that the projections of the side clamps are received within the locating gaps of the panels. Once received, the opposite end of the panels can be fixed to a fixing member by the locking members 40. The side clamps can be tightened when appropriate.

The above method of assembly allows the installation personnel to remain above the screen deck at all times and also allows the panels to be shifted slightly as they are positioned in the screen deck to ensure proper edge engagement with the side clamps and with adjacent panels.

The invention described herein is susceptible to variations, modifications and/or additions other than those specifically described and it is to be understood that the invention includes all such variations, modifications and/or additions which fall within the spirit and scope of the present disclosure.

1. A screening apparatus, including:
a plurality of spaced apart, substantially parallel elongate beams,
a plurality of screen panels mounted to the beams to form a broad, generally planar screening surface,
a pair of elongate side walls on opposite sides of the screening apparatus, side edges of edge panels of the screening surface extending in close facing relationship to the side walls,
elongate side clamps mounted to the side walls and having a bottom edge for bearing against an upper surface of the side edges of the edge panels of the screening surface,
the side edges of the edge panels including locating gaps and the side clamps including projections, whereby the projections are received within the locating gaps to locate the edge panels relative to the side clamps against movement of the edge panels lengthwise of the side clamps.

2. A screening apparatus according to claim 1, the projections having a width between opposite side surfaces measured lengthwise of the side clamps that is substantially equal to the spacing between facing side surfaces of the locating gaps, so that the side surfaces of the projections engage the side surfaces of the locating gaps.

3. A screening apparatus according to claim 1, the locating gaps having an inboard end which faces laterally to the side surfaces of the locating gaps and the projections extending into contact with the inboard end.

4. A screening apparatus according to claim 1, the projections extending from the bottom edge of the side clamp.

5. A screening apparatus according to claim 1, the locating gaps having an inboard end which faces laterally to the side surfaces of the locating gaps and the projections extending into the locating gaps but being spaced from the inboard end, plugs being connected to the projections to bridge between the projections and the inboard end so that facing surfaces of the plugs extend into contact with the inboard end.

6. A screening apparatus according to claim 5, each projection including an opening and each plug including a head, a neck and a base, the neck being of smaller diameter than the head and the base, the plugs being connected to the projections by the plug extending through the opening so that the head is positioned between the projection and the inboard end of the locating gap, the neck is within the opening and the base is positioned on the opposite side of the projection to the head, the head and the base being in engagement with opposite sides of the projection to secure the plug to the projection.

7. A screening apparatus according to claim 6, the opening being of substantially the same diameter as the neck and the plugs being formed from a flexible material so that the base can be collapsed and pushed through the opening and recover once it is through the opening.

8. A screening apparatus according to claim 6, the side clamps having a rear surface in facing engagement with the side walls and an opposite, front surface, the bottom edge of the side clamps extending between the front and rear surfaces of the side clamps and the projections extending from the bottom edge inboard of the rear surface, the base of the plugs extending between the projections and the rear surface of the side clamps so that the base is in engagement with the side walls.

9. A screening apparatus according to claim 5, the plugs being connected to the projections by a threaded connection, a bayonet connection or a snap fit connection.

10. A screening apparatus according to claim 1, the bridging portion of the plugs that bridges between the projections and the inboard end of the locating gaps having a width between opposite side surfaces measured lengthwise of the side clamps that is substantially equal to the spacing between facing side surfaces of the locating gaps, so that the side surfaces of the plugs engage the side surfaces of the locating gaps.

11. A screening apparatus according to claim 5, the bridging portion of the plugs that bridges between the projections and the inboard end of the locating gaps being generally square or rectangular.

13. A screening apparatus according to claim 5, the bridging portion of the plugs that bridges between the projections and the inboard end of the locating gaps being generally circular.

14. A screening apparatus according to claim 5, the edge panels having a height between the upper surface of the side edges of the edge panels and an opposite lower surface and the height of the projections being less than the height of the edge panels.

15. A screening apparatus according to claim 14, the height of the projections being less than half the height of the edge panels.

16. A screening apparatus according to claim 14, the projections extending from proximate the upper surface of the side edges of the edge panels and terminating prior to the opposite lower surface.

16. A screening apparatus according to claim 1, the side edges of the edge panels including two locating gaps spaced apart towards opposite sides of the edge panels.

17. A screening apparatus according to claim 1, the projections extending from the bottom edge inboard of the front surface, so that the bottom edge extends in front of the projections bearing against the upper surface of the side edges of the edge panels of the screening surface.
